(19) United States
(12) Patent Application Publication
(10) Pub. No.: US 2009/0167020 A1
(43) Pub. Date: Jul. 2, 2009

(54) DOUBLE-LOCKING CONNECTOR

(76) Inventors: Philippe Blivet, Rennes (FR); Philippe Poder, Guichen (FR); Philippe Le Quere, Betton (FR)

Correspondence Address: Muncy, Geissler, Olds & Lowe, PLLC, P.O. BOX 1364, FAIRFAX, VA, 22038-1364, US

(21) Appl. No.: 12/297,290

(22) PCT Filed: Apr. 26, 2007
(86) PCT No.: PCT/FR2007/000705

§ 371 Date: Oct. 15, 2008

(30) Foreign Application Priority Data
Apr. 28, 2006 (FR) 06 03840

(51) Int. Cl. F16L 37/084

(52) U.S. Cl. 285/317

(57) ABSTRACT

A connector for connecting a circuit element to a tubular endpiece has an external collar, the connector having a tubular body with means for connecting the tubular body to the circuit element and a housing to receive the endpiece. The housing has a sealing member and is defined by a wall pierced by a lateral opening, and receives a jumper that is movable transversely of the body between a projecting position for retaining the collar of the endpiece and a retracted position for releasing the collar. The body has a member for locking the jumper in the retaining position, the locking member being mounted on the body such that it is movable between a position which engages the jumper and a position which disengages the jumper.

### BACKGROUND OF THE INVENTION

1. Field of the Invention

The present invention relates to a connector for connecting a fluid transport circuit element to a tubular endpiece provided with an external collar. The circuit element may be a fluid supplying or receiving element such as a pump, a pipe, a tank, a valve, or an actuator, etc. The tubular endpiece may be associated with another circuit element like those mentioned above.

2. Brief Discussion of the Related Art

A connector generally comprises a tubular body comprising means for connecting it to the circuit element and a housing to receive the endpiece. The housing is provided with a sealing member and means for securing the endpiece in the housing. The securing means can be divided into two main groups, namely instantaneous connection means and non-instantaneous connection means.

Instantaneous connection means generally include a latch mounted on the body to be radially movable between a position that projects from the housing to retain the collar, and a position that is set back from the housing to release the collar. The latch includes a resilient element for returning it to its retaining position. The latch and the collar are shaped in such a manner that, when introducing the endpiece into the housing, the collar meets the latch in the retaining position and cooperates with the latch by friction to bring the latch into its retracted position against the return force, thereby releasing the cross-section for passing the collar before the latch returns resiliently into its retaining position once past the collar.

Connectors provided with instantaneous connection means are advantageous since they allow automatic connection of the endpiece to the body without requiring manipulation other than introducing the endpiece into the body. The element returning the latch into the retaining position opposes the movement of the latch towards its releasing position both when introducing the endpiece into the body and when an attempt is made to extract the endpiece from the body (even if in the contact surfaces of the collar and the latch are then as radial as possible to limit lifting of the latch). The return force is thus determined as a result of a compromise between producing an introduction force that is sufficiently small to allow manual connection, and producing maximum resistance to withdrawal of the endpiece. This means that such connectors are generally insufficiently resistant to pull-out of the endpiece when under high stress in applications such as when the pressure of the transported fluid is high and when the connector and the endpiece are subjected to high mechanical stresses.

In such applications, non-instantaneous connection means are generally employed; they include a jumper (or staple) that snap fits into the body and that can be moved by an operator through a lateral opening in the wall of the housing receiving the endpiece, between a position for retaining the collar of the endpiece and a position for releasing the endpiece.

The pull-out resistance of endpieces in such connectors is relatively good, but could be improved.

Thus, the invention aims to provide a connector having improved pull-out resistance and reduced risk of accidental disconnection following an error in manipulation.

### SUMMARY OF THE INVENTION

To this end, the invention provides a connector for connecting a circuit element to a tubular endpiece provided with an external collar, the connector comprising a tubular body including means for connecting it to the circuit element and a housing to receive the endpiece, the housing being provided with a sealing member and being defined by a wall pierced by a lateral opening receiving a jumper that is movable transversely of the body between a projecting position for retaining the collar of the endpiece and a retracted position for releasing the collar, the body including a member for locking the jumper in the retaining position, the locking member being mounted on the body such that it is movable between a position that engages the jumper and a position that disengages the jumper.

Thus, in the engaged position the locking member prevents the jumper from moving, so the jumper is thereby maintained in a positive manner in its retaining position.

In accordance with a particular embodiment, the locking member is a ring hinged on the wall of the housing in a manner such that it extends coaxially to the housing in the engaged position and flips into the released position from the engaged position.

Thus, the locking member is of simple construction and of limited bulk.

Preferably, the ring has an axially projecting tab and, when the ring is in the engaged position, the tab projects into the lateral opening to cooperate with the jumper in the retaining position so as to oppose movement of the jumper towards its releasing position; advantageously, since the ring is urged towards its disengaged position, the tab can bend resiliently such that when the tab is deformed, the ring defines a through cross-section that is smaller than a section of the collar and the tab comprises a step cooperating with a portion in relief of the wall of the housing to retain the ring in the engaged position.

Thus, when the ring is in its engaged position and the jumper is brought from its releasing position to its retaining position, the jumper deforms the tab that disengages from the portion in relief of the wall such that the ring is returned to its disengaged position. Movement of the ring towards its disengaged position indicates to the operator that the collar has passed the ring (since the tab has been able to deform) and the jumper (since the jumper has been able to descend into the retaining position). The operator is thus informed that the connection has been properly made.

Further scope of the applicability of the present invention will become apparent from the following detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of a connector in accordance with the invention;

FIG. 2 is a partial view of said connector in a condition that is not connected to the endpiece, in longitudinal section along plane II of FIG. 1;

FIGS. 3 to 6 are analogous views to that of FIG. 2 which illustrate the successive phases connecting an endpiece to the connector of the invention;

FIG. 7 is an analogous view to FIG. 2 of the connector connected to an endpiece after pressurizing a circuit in which the connector and the endpiece are installed;

FIG. 8 is a view of the connector of the invention without an endpiece, in section along the line VIII-VIII of FIG. 3; and

FIG. 9 is a view of the connector of the invention without an endpiece in a section along the line IX-IX of FIG. 5.

### DETAILED DESCRIPTION OF THE PREFERRED EMBODIMENTS

Referring to the figures, the connector of the invention, generally designated 1, is intended to connect a channel 101 of a circuit element 100 to a channel 201 of a circuit element 200 including a tubular endpiece 202 and provided with an external collar 203. The circuit element 100 here is a pipe. The circuit element 200 here is an element for supplying or receiving fluid the endpiece 202 of which is fixed thereto.

The connector 1 comprises a body 2 that is tubular, divided axially into a first section 2.1 intended to be connected to a circuit element 100 and a second section 2.2 intended to be connected to the endpiece 202.

The section 2.1 here is provided with barbs having a fir tree shaped profile intended to be forcibly introduced into the channel 101 of the circuit element 100. The section 2.1 may have other shapes, and may, for example, have the form of a nipple, or it may be identical to the section 2.2, or it may incorporate instantaneous connection means, etc.

The section 2.2 includes a stepped bore 3 having a final section 3.1 located on the side of the section 2.1 to receive the end of the endpiece 202, and an inlet section 3.2 opening to the outside of the body 2 or the connector 1 via an opening 3.3 to allow the endpiece 202 to be introduced into the housing 3. The inlet section 3.2 coaxially receives a blocking insert 4 that is tubular in shape and has an inside diameter that is substantially equal to the outside diameter of the endpiece 202, and a sealing member 5 extending between the blocking insert 4 and a shoulder 6 connecting the inlet section 3.2 to the final section 3.1. The inlet section 3.2 is defined by a wall 7 of the body 2 that exhibits a lateral opening 8 on the opening 3.3 side. The lateral opening 8, which is rectangular in shape, is defined on the side of the opening 3.3 by an edge 9 formed by a transverse surface of the body 2.

A jumper generally designated 10 is received in the lateral opening 8.

The jumper 10 has an upside-down U-shape and comprises an inner portion 11 formed as an arc of a circle having an inside diameter that is slightly greater than the outside diameter of the endpiece 202 and two parallel arms 12 spaced apart by a distance that is slightly greater than the outside diameter of the collar 203 of the endpiece 202. The inner portion 11 is sufficiently open to be able to be engaged laterally on the endpiece 202. Each arm 12 has a free end provided with an external step, here a tooth 13, and a central portion that is provided with an external bulge 14.

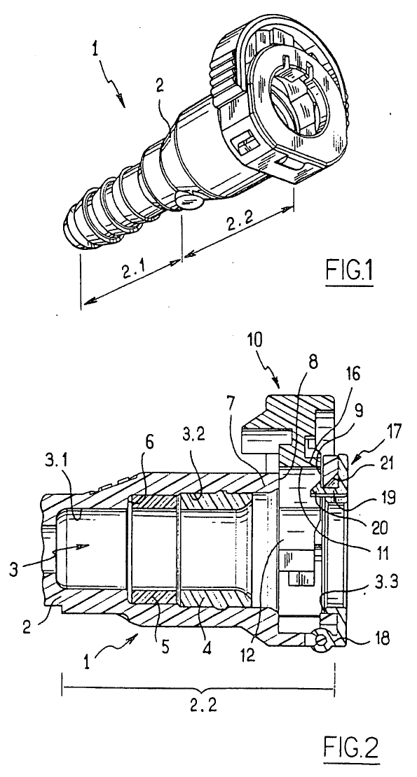

The jumper 10 is movable transversely relative to the body 1 in the lateral opening 8 between a retaining position (FIGS. 5, 6, 7 and 9) in which the inner portion 11 projects into the inlet section 3.2 and defines a through cross-section that is smaller than the section of the collar 203, and a releasing position (FIGS. 2, 3, 4 and 8) in which the inner portion 11 is retracted from the inlet section 3.2 to allow the collar 203 to pass through.

The jumper 10 is held in its releasing position by two portions in relief 15 of the body 2 projecting into the inlet section 3.2 and each received between the tooth 13 and the bulge 14 of one of the arms 12.

When the jumper 10 passes from its releasing position to its retaining position, the portions in relief 15 rub against the bulges 14 and pass to a side thereof that is opposed to the teeth 13. Passage of the bulges 14 constitutes a stiff point in the movement of the jumper 10 between the retaining position and the releasing position.

The teeth 13 and the bulges 14 constitute means for snap fitting or clip fitting the jumper 10 into the body 2 the arrangement of which can retain the jumper 10 resiliently in the body 2 in the retaining position and in the releasing position.

The jumper 10 includes a crown portion 16 projecting axially from the inner portion 11 of the jumper 10 in the direction of the opening 3.3. The crown portion 11 has an outside diameter that is slightly smaller than the diameter of the section 3.2 of the housing 3.

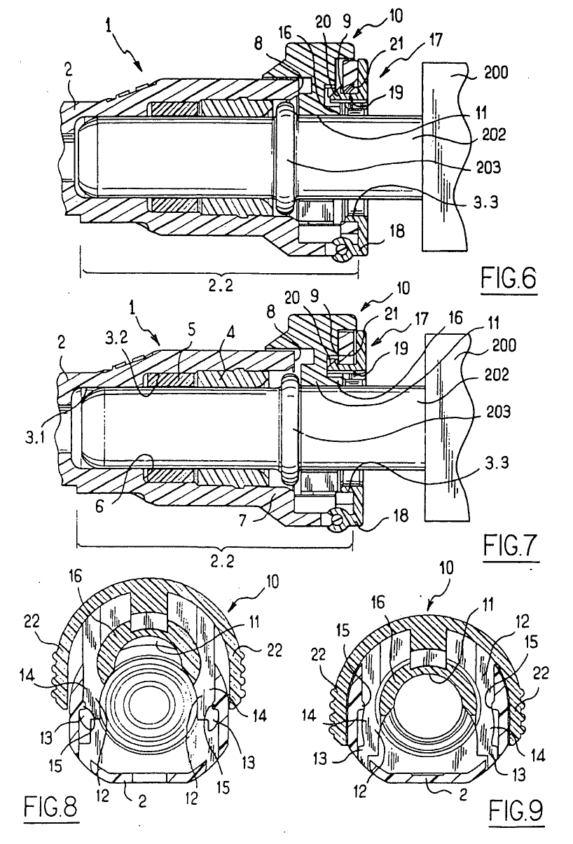

In its retaining position, the jumper 10 is axially movable between, in succession moving away from the blocking insert 4, an unlocked position (FIG. 6) and a locked position (FIG. 7). In the locked position, the jumper has moved back towards the opening 3.3 so that the crown portion 16 is embedded in the opening 3.3 by a length d. The crown portion 16 then passes beneath the wall 7, close to the edge 9 of the lateral opening 8, so that the edge 9 of the lateral opening 8 opposes the return of the jumper 10 to its releasing position. In the unlocked position, the crown portion 16 is disengaged from the opening 3.3 and from said edge 9 so that the jumper 10 can be brought into its releasing position.

A locking ring generally designated as 17 is mounted at the free end of the section 2.2 of the body 2 and comprises an edge 18 hinged on the end face of the body 2 between an engaged position in which the ring 17 is coaxial with the inlet section 3.2 of the housing 3 and a disengaged position in which the ring 17 is flipped out. Opposite to the edge 18, the ring 17 comprises a tab 19 that can bend resiliently, which projects axially from the internal periphery of the ring 17 and has a free end provided with an external step 20. The deformability of the tab 19 is such that when the tab is deformed, the ring defines a through cross-section that is smaller than a section of the collar. The tab 19 passes into the opening 3.3 and is received in the inlet section 3.2 and its free end projects into the lateral opening 8 when the ring 17 is in the engaged position. The step 20 then extends behind the edge 9 of the lateral opening 8 and has a rear radial face abutting against the edge 9 to stop the ring 17 from flipping into the disengaged position.

The step 20 has an inclined front face in the form of a ramp in order to cooperate by friction with the inner portion of the crown portion 16 and also with a chamfered surface 21 of the edge of the opening 3.3, as is explained below.

The function of the connector of the invention is described below.

Before connecting the endpiece to the connector, the jumper 10 is in the releasing position and the locking ring 17 is in the engaged position (see FIG. 2).

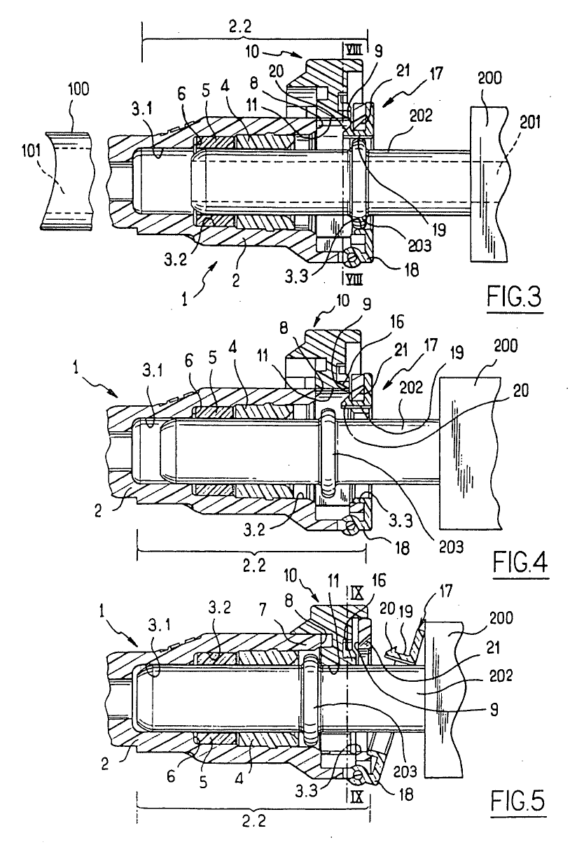

When an operator commences introducing the endpiece 202 into the body 2 of the connector 1, the operator will know that the connection has not been made so long as the collar 203 can be seen. When the collar 203 is in the locking ring 19, the collar 203 opposes bending of the tab 19 which opposes the descent of the jumper 10 into its retaining position (see FIG. 3). Thus, an inattentive operator no longer seeing the collar 203 because it is masked by the locking ring 17, cannot bring the jumper 10 into the retaining position to produce a connection. The risk of a connection error is thus reduced.

The movement of introducing the endpiece 202 is continued; the jumper 10 cannot descend into its retaining position while the collar 203 is facing the jumper 10 (see FIG. 4); the inner portion 11 of the jumper 10 comes into abutment against the collar 203 before moving into its retaining position.

When the collar 203 comes into abutment against the blocking insert 4, the introduction movement cannot be continued and the operator can bring the jumper 10 into the retaining position. The jumper 10, during its movement towards the retaining position, encounters the front face of the step 20 of the tab 19 and caused both bending of the tab 19 and a flipping motion of the ring 17. When the front face of the step 20 escapes to the inner portion of the crown portion 16 of the jumper 10, the front face of the step 20 is facing the chamfered surface 21 and rubs against this chamfered surface 21. The tab 19 returns resiliently to its non-deformed state; the friction of the front face of the step 20 against the chamfered surface 21 accentuates flipping of the locking ring 17. Thus, the locking ring 17 is ejected from its engaged position into its disengaged position (see FIG. 5), which indicates to the operator that the collar 203 is effectively retained. The operator may release the jumper 10 at this time. The jumper 10 remains in the retaining position, as the pressure of the bulges 14 on the portions in relief 15 of the housing 3.2 opposes accidental return of the jumper 10 towards its releasing position.

The operator then brings the locking ring 17 back into the engaged position (see FIG. 6) such that the free end of the tab 19 projects into the lateral opening 8 above the crown portion 16 and opposes movement of the jumper 10 towards its releasing position.

While the circuit containing the elements 100 and 200 are being placed under pressure, the endpiece 202 tends to move back and bring the jumper 10 into the locked position (see FIG. 7). The crown portion 16 then no longer simply extends beneath the tab 19, but also under the edge 9 defining the lateral opening 8, which prevents the jumper 10 from returning to the releasing position.

Disconnection is possible by flipping the ring 17 into the disengaged position and bringing the jumper 10 to the releasing position. It should be noted that the jumper 10 includes flaps 22 extending either side of the body 2 when the jumper 10 is in the retaining position to allow the jumper 10 to be manipulated.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

In particular, the body of the connector may have a shape different from that described: the housing may include more than two sections, the blocking insert and the sealing element may have different shapes, etc. The structure of the locking member may also differ from that described, and may, for example, comprise a catch mounted on the external surface of the body 2 to slide between the retained and releasing positions.

The tab 19 may cooperate with any type of relief in order to retain the locking ring 17 in the retaining position and, for example, a reinforcement provided in the wall 7 close to the opening 3.3.

The length d may be greater than that shown in FIG. 7.

While the embodiment shows that the jumper is provided with means for snap fitting it into the body, arranged so that the jumper is resiliently retained in the body in the retaining position and in the releasing position, the means on the body of the jumper for retaining it in the releasing position may function by snap fitting or other mode, such as a simple abutment opposing complete withdrawal of the jumper.

What is claimed is:

1. A connector for connecting a circuit element to a tubular endpiece provided with an external collar, the connector comprising:
a tubular body including means for connecting the tubular body to the circuit element; and
a housing to receive the endpiece, the housing being provided with a sealing member and defined by a wall pierced by a lateral opening and receiving a jumper that is movable transversely of the body between a projecting position for retaining the collar of the endpiece and a retracted position for releasing the collar,
wherein the body includes a member for locking the jumper in the retaining position, the locking member being mounted on the body such that it is movable between a position that engages the jumper and a position that disengages the jumper.

2. A connector according to claim 1, wherein the locking member is a ring hinged on the wall of the housing in a manner such that it extends coaxially to the housing in the engaged position and flips into the released position from the engaged position.

3. A connector according to claim 2, wherein the ring has an axially projecting tab and, when the ring is in the engaged position, the tab projects into the lateral opening to cooperate with the jumper in the retaining position so as to oppose movement of the jumper towards its releasing position.

4. A connector according to claim 3, wherein, when the ring is urged towards its disengaged position, the tab can bend resiliently such that when the tab is deformed, the ring defines a through cross-section that is smaller than a section of the collar and the tab comprises a step cooperating with a portion in relief of the wall of the housing to retain the ring in the engaged position.

5. A connector according to claim 4, wherein the portion in relief of the wall of the housing is formed by an edge of the lateral opening.

6. A connector according to claim 1, wherein the jumper in the retaining position is axially movable between a locked position in which the jumper has an abutment portion engaged under an edge of the lateral opening and an unlocked position in which the abutment portion escapes from the edge of the lateral opening.

7. A connector according to claim 1, comprising means on the body of the jumper for retaining it in the releasing position.

8. A connector according to claim 7, wherein the jumper is provided with means for snap fitting the jumper into the body, arranged such that the jumper is retained resiliently in the body in the retaining position and in the releasing position.
